(19) United States
(12) Patent Application Publication
(10) Pub. No.: US 2018/0287665 A1
(43) Pub. Date: Oct. 4, 2018

(54) POWER LINE-BASED COMMUNICATION METHOD AND DEVICE

(71) Applicant: JITBoundary United Production Inc., Taichung City (TW)

(72) Inventors: Ying-Diean HWANG, Taichung City (TW); Po-Wen KO, Taichung City (TW)

(21) Appl. No.: 15/939,417

(22) Filed: Mar. 29, 2018

(30) Foreign Application Priority Data
Mar. 30, 2017 (TW) 106110750

(51) Int. Cl. H04B 3/54

(52) U.S. Cl. CPC H04B 3/542; H04B 2203/5483; H04B 3/544

(57) ABSTRACT

The present invention involves utilizing AC power lines adapted for connection to an AC power source and a signal line to perform baseband signal transmission and communication. According to the invention, a threshold voltage is provided as a comparison reference for an AC input voltage to determine whether the communication is permitted. If the AC input voltage is greater than the threshold voltage, the communication is permitted. On the contrary, if the AC input voltage is smaller than the threshold voltage, the communication is not permitted. By virtue of the invention, the initiation time and the termination time of the baseband signal communication for each load tend to be substantially identical. Reliability is thus increased and noise interference problem is not created.

### PRIORITY CLAIM

This application claims priority to R.O.C. Patent Application No. 106110750 filed Mar. 30, 2017, the entirety of which is incorporated herein by reference.

### BACKGROUND OF THE INVENTION

### 1. Field of the Invention

The present invention relates to a communication method, as well as an device, where AC power lines adapted for connection to an AC power source and a signal line are used to perform transmission of baseband signals.

### 2. Description of the Related Art

In the existing home control system, a user operates a mobile device such as a smart phone or a tablet. Through the connection between the network and a control device, the user operates the mobile device to generate a control signal, which is used to control each of the peripheral devices in the home through the control device. The peripheral devices may be various electrical devices in the home, such as television set, lamps, electric fans, and air conditioner, and the like. The user can control each of the peripheral devices directly by operating the mobile device, and does not need to separately use remote controller of each peripheral device to remotely control the peripheral device, thereby making it easier for the user to use peripheral devices in the home.

Said home control system must rely on network to connect to the mobile device. Therefore, the existing home control system demands a network device capable of connecting to a network in order to enable a user to directly operate the mobile device. Through connecting to the network device via a network and further through a network device to connect to the control device, the user is allowed to control the individual peripheral device in the home through the mobile device. In addition, according to the current most advanced technique in the industry, the control signal transmission between a control device and a electric device or a peripheral device is to embed or install a management mechanism or device in the electric device or the peripheral device. Through the wireless transmission technology (Wi-Fi or Zigbee), the control device is used to transmit the control signal to the gateway or base station via a wireless network or Internet, and then a wireless transmission technology is used to transmit management control signal instructions of each electric device or peripheral device.

For said control signal transmission through the wireless transmission technology, Wi-Fi has the advantages of high-speed data transmission. However, when applied to electrical devices or peripheral devices (such as lamp control in wireless lighting system), since the data flow of control signals transmitted between the control device and the lamp is very low, the use of high transmission-rate Wi-Fi signal for transmitting the low data flow control signals is inevitably a waste of resources. Furthermore, when the Wi-Fi conversion module is compared with the general wireless communication module with low transmission rate, production cost of Wi-Fi conversion module is higher, communication protocol complex and energy consumption higher, and electric device or peripheral device requires an additional wireless transmission module. Therefore, this would cause cost increase in constructing a wireless transmission control system.

As a result, a powerline communication (PLC) technology has emerged on the market, which is a technology that uses power line (power source line) to get Internet access. The power source line is the most common line in every room of an existing house. Most of the products are powered by the power line. The power line communication technology is to convert the data into a tandem for combining with high-frequency signal to synthesize a carrier signal, which is then coupled to the power line. The use of power line for data transmission is made possible by employing a dedicated power line modulation/demodulation to separate high-frequency signals from the power line, and then sending the high-frequency signals to the terminal equipment for power line modulation/demodulation to get the signals from the power line.

The use of a power line as the backbone transmission medium of the home (region) network does not require re-wiring, which can save construction costs and time. However, if the mains supply and the communication carrier of power line are simultaneously transmitted, the communication carrier of power line is easily interfered by the noise generated by other electrical equipment. This may easily result in the failure of transmitting a certain part of data packets and cause the transmission rate to drop. In severe cases, the PLC network may be led to paralysis.

### SUMMARY OF THE INVENTION

One objective of the invention is to provide a communication method, as well as a device, where AC power lines adapted for connection to an AC power source and a signal line are used to perform transmission of baseband signals.

The invention mainly involves utilizing AC power lines adapted for connection to an AC power source and a signal line to perform transmission and communication of baseband signals, wherein a threshold voltage is provided as a comparison reference for an AC input voltage to determine whether the communication is permitted. If the AC input voltage is greater than the threshold voltage, the communication is permitted. On the contrary, if the AC input voltage is smaller than the threshold voltage, the communication is not permitted. By virtue of the invention, the initiation time and the termination time of the baseband signal communication for each load tend to be substantially identical. Reliability is thus increased and noise interference problem is not created.

The invention further provides a power line-based communication device, comprising:

an AC power input terminal having a first power line, a second power line and a signal line;

a rectifying unit electrically connected to the AC power input terminal;

a voltage comparison module adapted to receive an AC input voltage through the rectifying unit and set with a threshold voltage for comparing with the AC input voltage; and

a signal transmission interface connected to the voltage comparison module and the signal line, respectively.

The present invention involves using the threshold voltage value set by the voltage comparison module to compare with the input AC input voltage. If the AC input voltage is greater than the threshold voltage value, the signal transmission interface is permitted to send a baseband signal to the signal line for communication. On the contrary, if the AC input voltage is smaller than the threshold voltage, the communication is not permitted. The loads connected to the communication device disclosed herein may be a light source (such as a light emitting diode lamp), a sensor, or a display, etc. The invention allows baseband signal communication to proceed, while electricity is transmitted. A user can directly accomplish smart remote control simply by connecting the load to a conventional three-wire connector. The user is allowed to turn on, turn off or even dim the light source by using the power line. The invention has advantages of achieving wide coverage, easy connection and high transmission rate by using existing wires.

Compared with the traditional powerline communication (PLC), the invention utilizes the signal line for data transmission, in contrast to the conventional way of directly loading signals on the power lines, and this modification not only improves the noise interference problem of power line communication, but also spares the use of an isolation system and a modulation/demodulation system.

### BRIEF DESCRIPTION OF THE DRAWINGS

FIG. 1 is a structural schematic diagram of a communication device according to the first embodiment of the invention;

FIG. 2 is a structural schematic diagram of a communication device according to the second embodiment of the invention;

FIG. 3 is the signal waveform diagram according to the second embodiment of the present invention;

FIG. 4 is a structural schematic diagram of a communication device according to the third embodiment of the invention;

FIG. 5 is the signal waveform diagram according to the third embodiment of the present invention;

FIG. 6 is a structural schematic diagram of a communication device according to the fourth embodiment of the invention;

FIG. 7 is a structural schematic diagram of a communication device according to the fifth embodiment of the invention;

FIG. 8 is a structural schematic diagram of a communication device according to the sixth embodiment of the invention;

FIG. 9 is a structural schematic diagram of a communication device according to the seventh embodiment of the invention;

FIG. 10 is a structural schematic diagram of a communication device according to the eighth embodiment of the invention; and

FIG. 11 is a schematic diagram showing the communication device according to the invention in use.

### DETAILED DESCRIPTION OF THE INVENTION

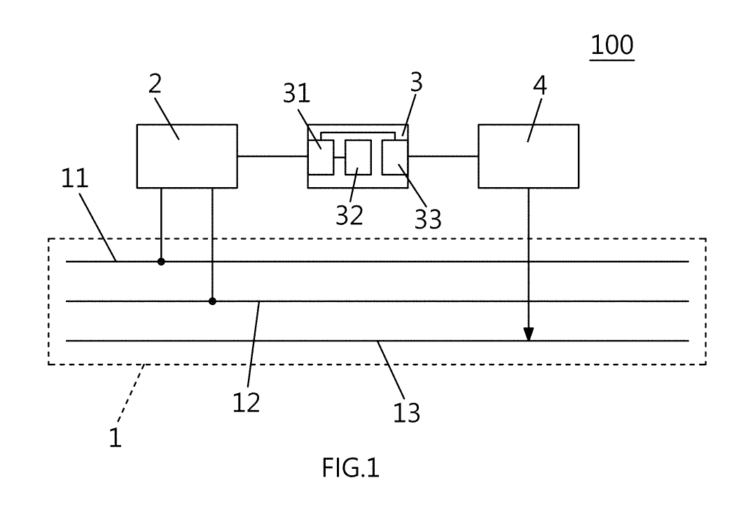

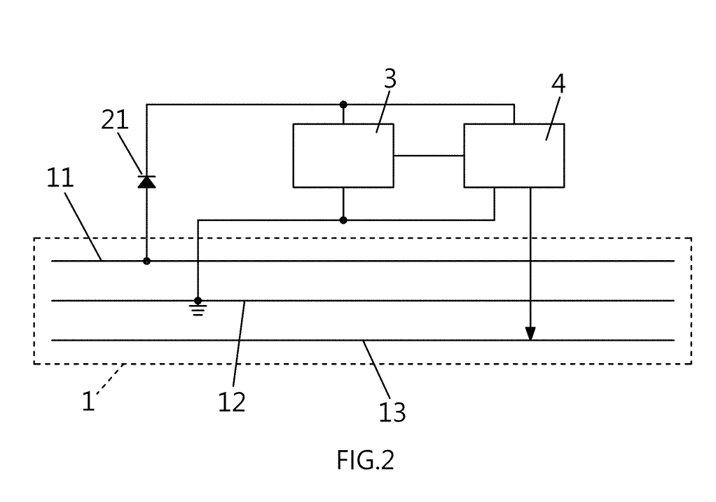

The communication method according to the invention mainly involves utilizing AC power lines adapted for connection to an AC power source and a signal line to perform baseband signal transmission and communication, wherein a threshold voltage is set as a comparison reference for an AC input voltage to determine whether the communication is permitted. FIG. 1 is a structural schematic diagram showing a communication device according to the first embodiment of the invention. According to the invention, a power line-based communication device 100 comprises an AC power input terminal 1, a rectifying unit 2, a voltage comparison module 3 and a signal transmission interface 4, wherein the AC power input terminal 1 has a first power line 11, a second power line 12 and a signal line 13. The rectifying unit 2 is electrically connected to the AC power input terminal. In the second embodiment shown in FIG. 2, the rectifying unit may be a half-wave rectifier 21 electrically connected to the first power line 11.

The voltage comparison module 3 comprises a voltage dividing unit 31, a setting unit 32 and a comparison unit 33. The comparison unit 33 is electrically connected to the voltage dividing unit 31 and the setting unit 32, respectively. The voltage comparison module 3 receives an AC input voltage from the AC power input terminal 1 through the rectifying unit 2 and divides the voltage to generate a divided voltage signal. According to the second embodiment shown in FIG. 2, one end of the voltage comparison module 3 is electrically connected to the half-wave rectifier 21 and the other end thereof is electrically connected to the second power line 12, and the setting unit 32 of the voltage comparison module 3 is set with a threshold voltage (Vth) for comparison with the AC input voltage.

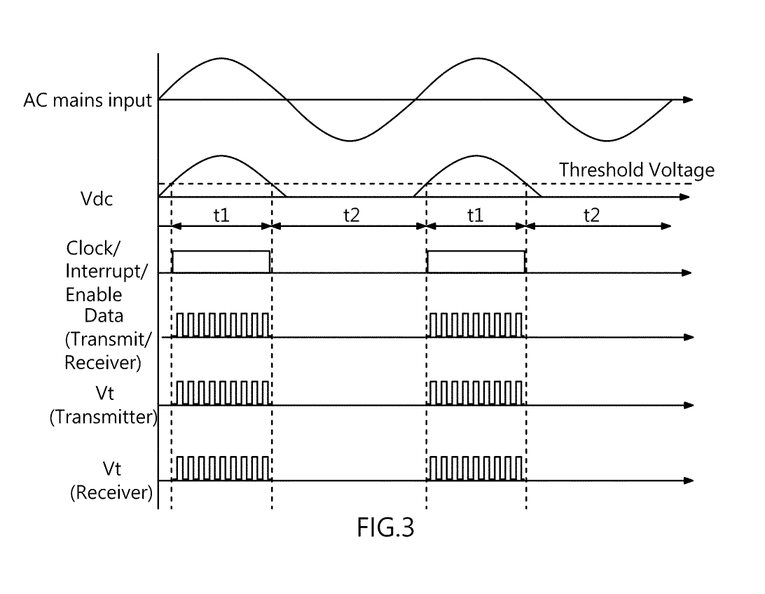

According to the embodiment shown in FIG. 2, in the case where the rectifying unit is a half-wave rectifier 21, the signal level reference ground is fixedly connected to the second power line 12. Referring to the signal waveform diagram shown in FIG. 3, when the AC power is input through the AC power input terminal 1, the AC power is rectified by the half-wave rectifier 21, and the rectified power is transmitted to the voltage comparison module 3 for comparison to obtain a communication cycle time including a duty time t1 and a forbidden time t2. The communication cycle time is an AC cycle, and the communication frequency is a multiple of the AC frequency. The duty time t1 is the time in which the AC input voltage is greater than the threshold voltage. The voltage level is clear, allowing the signal transmission interface 4 to communicate. The signal transmission interface 4 can proceed with transmission and communication of baseband signals through the signal line 13. The forbidden time t2 is the time in which the AC input voltage is lower than the threshold voltage. The voltage level is unclear, prohibiting the signal transmission interface 4 to communicate.

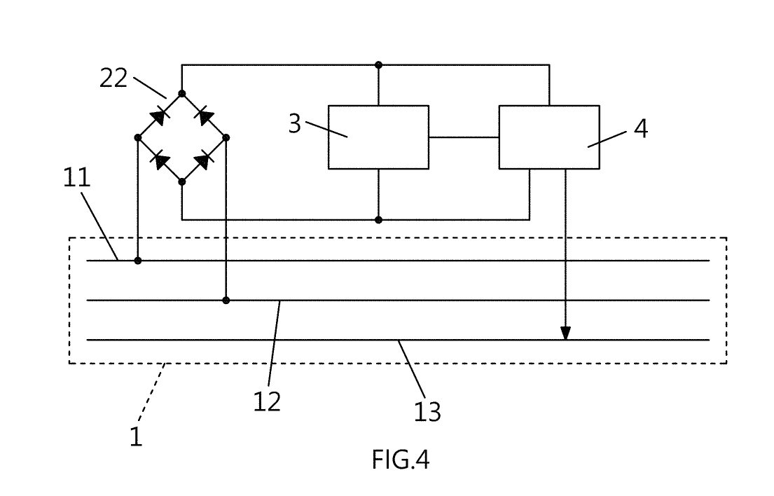

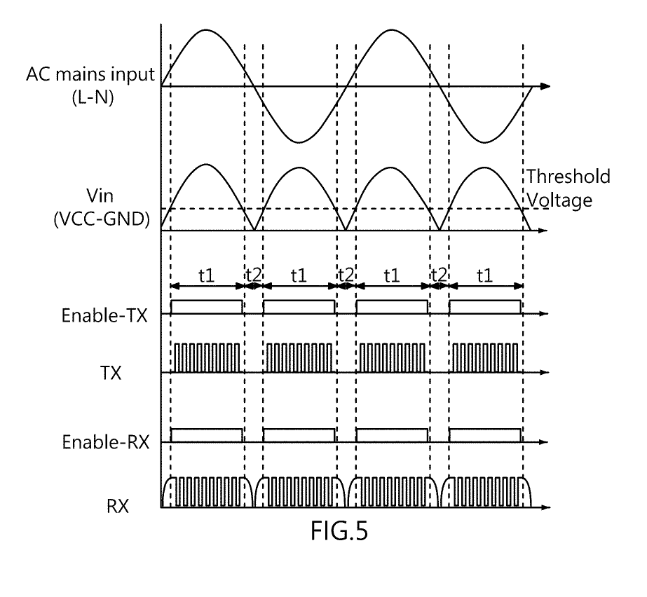

According to the third embodiment shown in FIG. 4, the rectifying unit is a full-wave rectifier 22 electrically connected to the first and second power lines 11, 12, respectively. The voltage comparison module 3 is electrically connected to the full-wave rectifier 22, whose signal level reference ground is in compliance with the AC power to correspond to the first and second power lines 11, 12 through the full-wave rectifier 22. When the input AC is in the positive half-wave, the signal level reference ground is located on the second power line 12. When the input AC is in the negative half wave, the signal level reference ground is located on the first power line 11. Referring to the signal waveform diagram shown in FIG. 5, when the AC power is input through the AC power input terminal 1, the full-wave rectifier 22 functions for rectification to transmit the rectified power to the voltage comparison module 3 for comparison. After comparison, a communication cycle time including a duty time t1 and a forbidden time t2 is obtained, wherein the communication cycle time is an AC cycle, and the communication frequency is a multiple of the AC frequency. The duty time t1 is the time in which the AC input voltage is greater than the threshold voltage. The voltage level is clear, allowing the signal transmission interface 4 to communicate. The signal transmission interface 4 can proceed with transmission and communication of baseband signals through the signal line 13. The forbidden time t2 is the time in which the AC input voltage is lower than the threshold voltage. The voltage level is unclear, prohibiting the signal transmission interface 4 to communicate.

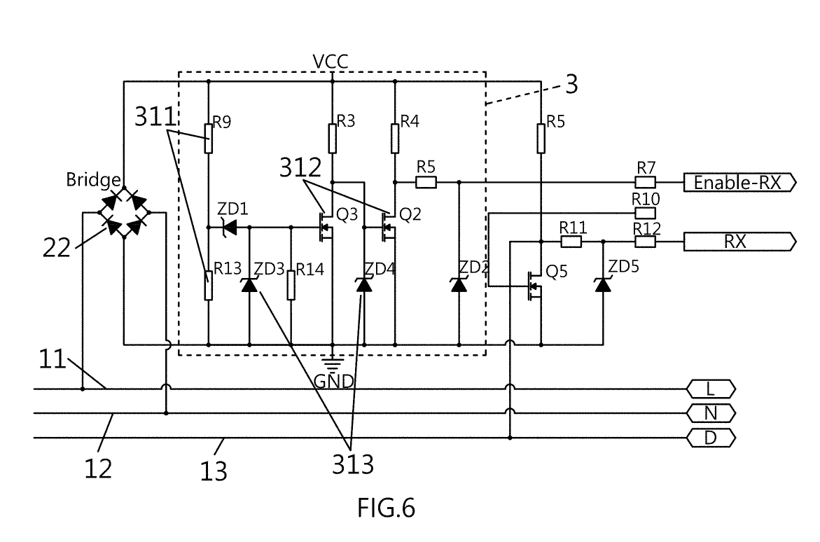

Referring to FIG. 6, which is a structural schematic diagram showing a communication device according to the fourth embodiment of the invention. The voltage dividing unit of the voltage comparison module 3 can be two resistors 311 connected in series, which are electrically connected to the full-wave rectifier 22 to achieve voltage dividing effect. The use of field-effect transistors (MOSFET) 312, in conjunction with Zener diodes 313, constitutes a comparison unit that can proceed with comparison of the AC input voltage with the threshold voltage value to determine the period during which communication is permitted. This embodiment may use a higher voltage signal for communication to facilitate the signal level judgment.

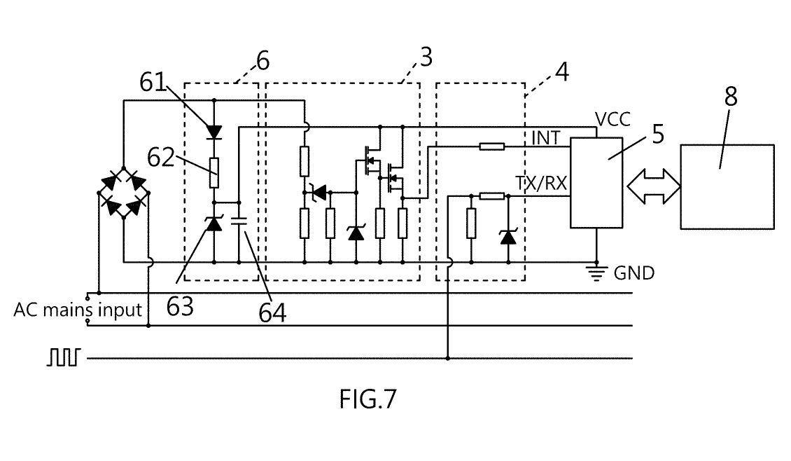

Referring to FIG. 7, which is a structural schematic diagram showing a communication device according to the fifth embodiment of the invention. The embodiment herein is further provided with a microprocessor unit 5 for electrical connection to a load 8. The microprocessor 5 is electrically connected to the signal transmission interface 4, and the communication and transmission of baseband signals are performed by directly using the TTL I/O pins of the microprocessor 5 for transmission and reception. According to the embodiment shown in FIG. 7, a non-isolated power conversion unit 6 may be further provided. The non-isolated power conversion unit 6 is electrically connected to the rectifying unit and the voltage comparison module 3, respectively, and adapted to convert the rectified AC power into DC power. According to the embodiment shown in FIG. 7, a rectifier diode 61 connected in series with a resistor 62 is arranged downstream the full-wave rectifier 22 for voltage reduction, and a Zener diode 63 connected in parallel to a capacitor 64 is arranged downstream the resistors, which constitute a non-isolated power conversion unit 6 for providing a simple DC power source. The non-isolated power conversion unit herein is provided for illustrative purpose only, and other non-isolated power conversion architectures known in the art are also applicable in the invention.

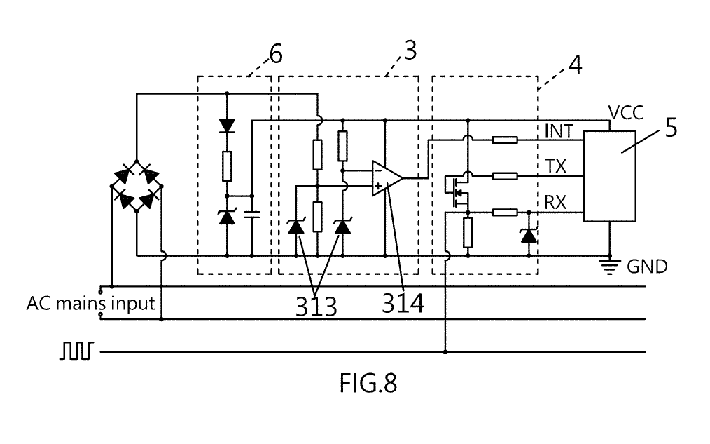

Referring to FIG. 8, which is a structural schematic diagram showing a communication device according to the sixth embodiment of the invention, whose structure is substantially the same as that of the fifth embodiment. The only difference is that in the sixth embodiment, the voltage comparison function is performed by an operational amplifier 314 in conjunction with the Zener diodes 313 to give a reference voltage, which constitutes a voltage judgment loop.

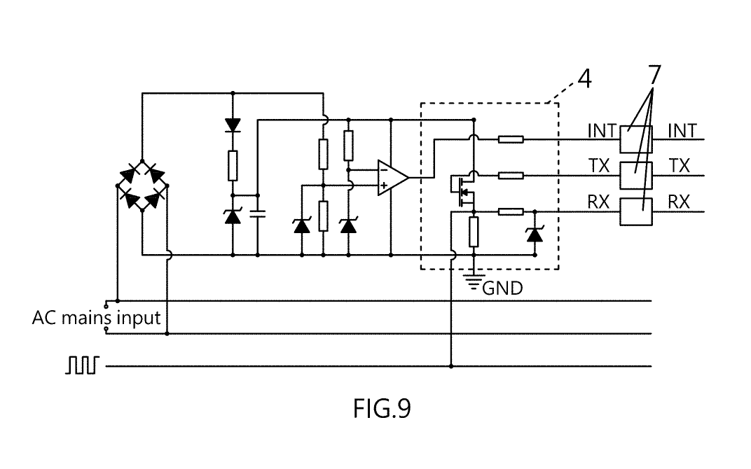

Referring to FIG. 9, which is a structural schematic diagram showing a communication device according to the seventh embodiment of the invention, whose structure is substantially the same as that of the sixth embodiment. The only difference is that in the seventh embodiment, no processor unit is provided. Instead, at least one isolation unit 7 (which may by way of example be an optical coupler or a signal coupler) is provided. The isolation unit 7 is electrically connected to the signal transmission interface 4, and the TX/RX/INT ports of the signal transmission interface 4 are respectively connected to an isolation unit 7 for isolation from the rear control system.

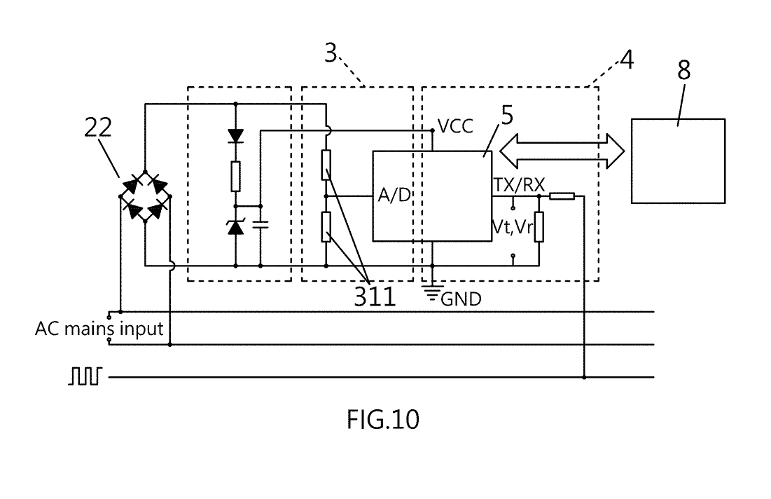

In said embodiment, part of the functions of the voltage comparison module (such as the function of controlling the communication cycle, etc.) is performed by a microprocessor unit. Referring to FIG. 10, which is a structural schematic diagram showing a communication device according to the eighth embodiment of the invention. The voltage comparison module is provided with a voltage dividing unit, which may be two series-connected resistors 311. In the same manner, the AC input voltage from the AC power input terminal 1 is received through the rectifying unit (with full-wave rectifier 22 as an example in this embodiment) and divided to generate a divided voltage signal. In addition, the microprocessor unit 5 is electrically connected to the voltage comparison module 3 and the signal transmission interface 4, respectively, and adapted for electrical connection to a load 8. The divided voltage signal obtained by the voltage dividing unit is transmitted to the input pins of the microprocessor unit 5 having A/D function; the internal A/D function of the microprocessor unit 5 is used to judge the voltage position, and the software program built in the microprocessor unit 5 is used to control the communication cycle of the signal transmission interface 4.

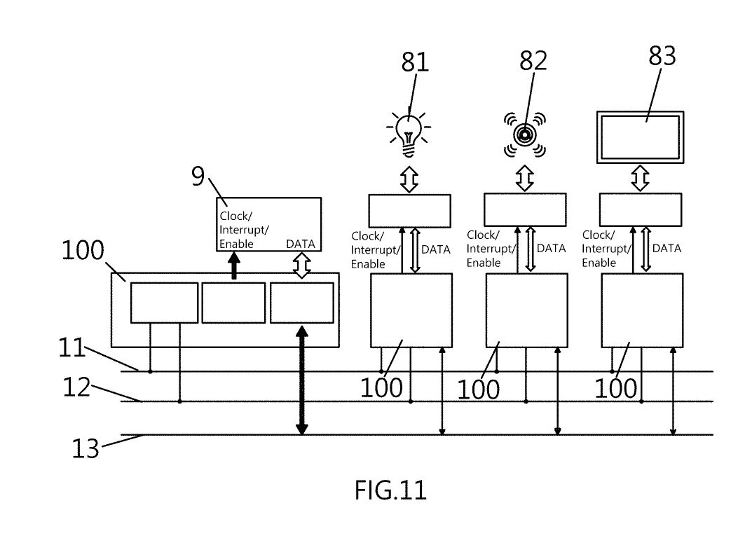

The present invention involves a baseband signal transmission and communication by using AC power lines adapted for connection to an AC power source and a signal line, which can be applied to a load that needs to receive mains supply. As shown in FIG. 11, the invention may be applied to a light source 81 (such as a light emitting diode lamp), a sensor, or a display, etc. While the electricity is transmitted, baseband signal communication can also proceed. A user is allowed to directly accomplish smart remote control simply by connecting each load to a conventional three-wire connector. Taking the light sources 81 as an example, a control system 9 can be electrically connected in series to a plurality of light sources 81 through the power lines 11, 12, and each light source 81 is electrically connected to the power lines 11, 12 through the communication device 100 of the invention. Users can preset various control modes via the control system, such as turning on or turning off the light source and adjusting brightness of the light source. The control system can convert various control modes into baseband signals, and the power line is used for transmission of the baseband signal, which is not only capable of controlling on or off of the light source or evening dimming by using the power line, but also has the advantages of achieving wide coverage, easy connection and high transmission rate by using existing wires. Comparison of the threshold voltage value with the AC input voltage to determine the communication cycle makes the communication cycle of the baseband signals counted from its initiation to termination to be substantially identical for each light source, thus greatly improving the reliability and ensuring that the AC input voltage can be developed to sufficiently high signal level in order to ensure that the equivalent impedance of the rectifying unit meets the transmission requirement of baseband signals.

It is worthwhile to note that compared with the traditional powerline communication (PLC) technology, the invention utilizes a signal line incorporated in the power lines for data transmission rather than directly loading signals on the power lines, which not only improves the noise interference problem of power line communication, but also spare the use of isolation system and modulation/demodulation system to achieve a simpler system configuration.

We claim:

1. A power line-based communication device, comprising:
an AC power input terminal having a first power line, a second power line and a signal line;
a rectifying unit electrically connected to the AC power input terminal;
a voltage comparison module adapted to receive an AC input voltage through the rectifying unit and set with a threshold voltage for comparing with the AC input voltage; and
a signal transmission interface connected to the voltage comparison module and the signal line, respectively.

2. The device according to claim 1, wherein the rectifying unit is a half-wave rectifier electrically connected to the first power line, and the voltage comparing module is electrically connected at its one end to the half-wave rectifier and electrically connected at the other end to the second power line.

3. The device according to claim 1, wherein the rectifying unit is a full-wave rectifier electrically connected to the first and second power lines, respectively, and the voltage comparison module is electrically connected to the full-wave rectifier.

4. The device according to claim 1, wherein the voltage comparison module comprises a setting unit for setting the threshold voltage value, and a comparison unit electrically connected to the setting unit for comparing the threshold voltage value with the received AC input voltage.

5. The device according to claim 4, further provided with a micro-processor unit adapted for electrical connection to a load, wherein the micro-processor unit is electrically connected to the signal transmission interface.

6. The device according to claim 4, wherein a non-isolated power conversion unit is further provided and electrically connected to the rectifying unit and the voltage comparison module, respectively.

7. The device according to claim 4, wherein at least one isolation unit is further provided for connection to the signal transmission interface.

8. The device according to claim 2, wherein the voltage comparison module comprises a setting unit for setting the threshold voltage value, and a comparison unit electrically connected to the setting unit for comparing the threshold voltage value with the received AC input voltage.

9. The device according to claim 8, further provided with a micro-processor unit adapted for electrical connection to a load, wherein the micro-processor unit is electrically connected to the signal transmission interface.

10. The device according to claim 8, wherein a non-isolated power conversion unit is further provided and electrically connected to the rectifying unit and the voltage comparison module, respectively.

11. The device according to claim 8, wherein at least one isolation unit is further provided for connection to the signal transmission interface.

12. The device according to claim 3, wherein the voltage comparison module comprises a setting unit for setting the threshold voltage value, and a comparison unit electrically connected to the setting unit for comparing the threshold voltage value with the received AC input voltage.

13. The device according to claim 12, further provided with a micro-processor unit adapted for electrical connection to a load, wherein the micro-processor unit is electrically connected to the signal transmission interface.

14. The device according to claim 12, wherein a non-isolated power conversion unit is further provided and electrically connected to the rectifying unit and the voltage comparison module, respectively.

15. The device according to claim 12, wherein at least one isolation unit is further provided for connection to the signal transmission interface.

16. The device according to claim 1, further provided with a micro-processor unit adapted for electrical connection to a load, wherein the micro-processor unit is electrically connected to the voltage comparison module and the signal transmission interface, respectively.

17. The device according to claim 2, further provided with a micro-processor unit adapted for electrical connection to a load, wherein the micro-processor unit is electrically connected to the voltage comparison module and the signal transmission interface, respectively.

18. The device according to claim 3, further provided with a micro-processor unit adapted for electrical connection to a load, wherein the micro-processor unit is electrically connected to the voltage comparison module and the signal transmission interface, respectively.
